(19) United States
(12) Patent Application Publication
(10) Pub. No.: US 2004/0243920 A1
(43) Pub. Date: Dec. 2, 2004

(54) Document input/output journal management system and method

(75) Inventor: Hiroyuki Kato, Shizuoka-ken (JP)

Correspondence Address: FOLEY AND LARDNER, SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/446,701

(22) Filed: May 29, 2003

(51) Int. Cl. G06F 15/00

(52) U.S. Cl. 715/500

(57) ABSTRACT

A document processing system and method for processing document jobs includes a document input unit that receives a document to be processed by a document process, a document processing unit that processes the received document in accordance with the document process, and a document output unit that outputs a process result in accordance with the document processing by the document processing unit. A document input/output journal management unit includes a job log that records information regarding each document process performed by the document processing system, a user management information table that includes identification information of users of the document processing system, and a document input/output journal that collects and stores selected information from the job log and the user management information table relating to document processes that are processed by the document processing unit.

### FIELD OF THE INVENTION

The present invention relates generally to input/output processing and, more particularly, to a system and method for managing document input/output journal information.

### BACKGROUND OF THE INVENTION

In conventional document processing and management systems, users can perform a variety of document processes. The document processes, also referred to as jobs, include, for example, sending and receiving faxed documents, sending and receiving documents by e-mail, copying documents, scanning documents, printing documents and creating and editing documents. The management and storage of the documents, as well as performing the various document processes, can be handled by a document processing device, such as a multi-function peripheral.

When carrying out a document process, information regarding the performance of the document process can be recorded in a job log. The job log records various information about the document process such as the time it was performed, the status of the document process, and some identifier of the user creating the document process.

In addition to the job log, a document processing device may include a user management information table, such as an address book, which stores information regarding the users of the document processing device, such as their name, e-mail address and telephone number. Other information that may be stored in the document processing device includes a job template table, which includes information for performing one or more document processes in a predetermined manner. The document processing device can also store and manage documents stored in an internal storage area.

All of this information stored in the document processing device can be reviewed by users, such as a network administrator, to analyze the performance and actions of the document processing device. For example, the network administrator can review the job log to identify where problems have occurred, or a user can refer to the user management information table to determine how to contact another user.

Often, information stored in one of the tables in the document processing device, such as the job log, user management information table or the job template table may refer to information in another table. For example, the job log may include a unique value that identifies a user that created a document process, but to identify the name of that user requires reference to the user management information table. It therefore would be desirable to be able to link information from the various tables into a separate table that would facilitate the review and analysis of the performance and actions of the document processing device.

### SUMMARY OF THE INVENTION

Briefly, in one aspect of the invention, a document processing system and method for processing document jobs includes a document input unit that receives a document to be processed by a document process, a document processing unit that processes the received document in accordance with the document process, and a document output unit that outputs a process result in accordance with the document processing by the document processing unit. A document input/output journal management unit includes a job log that records information regarding each document process performed by the document processing system, a user management information table that includes identification information of users of the document processing system, and a document input/output journal that collects and stores selected information from the job log and the user management information table relating to document processes that are processed by the document processing unit.

### BRIEF DESCRIPTION OF THE DRAWINGS

FIG. 1 is a block diagram of a document processing system according to an embodiment of the present invention.

FIGS. 2A and 2B are examples of a job log and a user management information table, respectively, according to an embodiment of the present invention.

FIGS. 3A, 3B and 3C are examples of a scan job template, an agent information table and a scanning settings table, respectively, according to an embodiment of the present invention.

FIG. 4 is an example of a document input/output journal according to an embodiment of the present invention.

FIG. 5 is a flow diagram for performing a document process according to an embodiment of the present invention.

FIGS. 6A and 6B are flow diagrams for creating the document input/output journal and analyzing the document input/output journal, respectively, according to an embodiment of the present invention.

FIGS. 7A, 7B and 7C are examples of a document input/output journal restructured in accordance with the analysis process of FIG. 6B.

### DETAILED DESCRIPTION OF THE PREFERRED EMBODIMENT

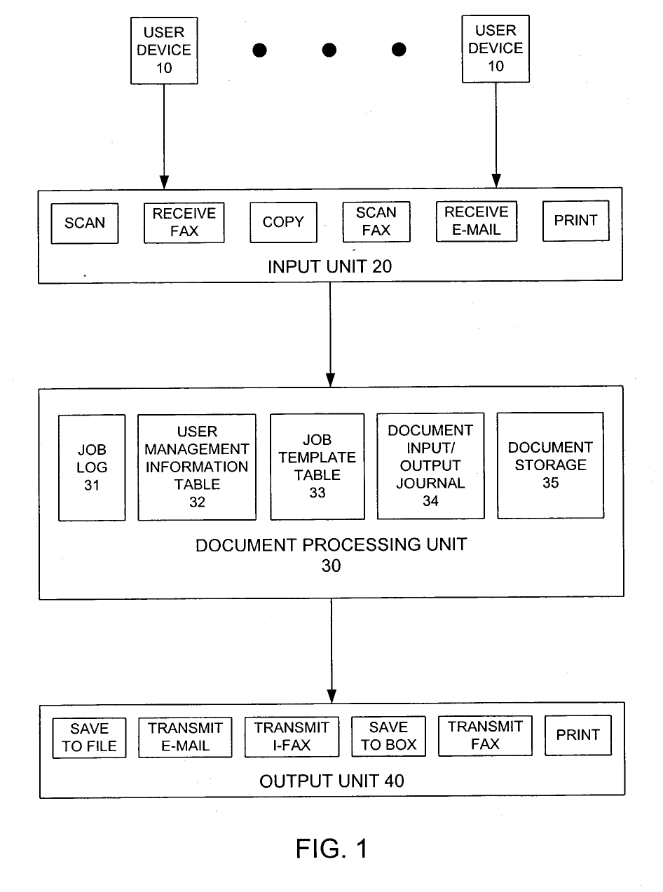

FIG. 1 is a block diagram of a document processing system according to an embodiment of the present invention. As shown in FIG. 1, the document processing system includes one or more user devices 10, an input unit 20, a document processing unit 30, and an output unit 40. Each of these components can be coupled together by a network connection or by a direct communication connection. The network connection may be implemented by a local network, such as a LAN, or a public network, such as the Internet.

The user device 10 may include a PC, a mobile phone, a PDA, a magnetic card or some combination thereof, or any other computing device. Each preferably includes a CPU, a main memory, a ROM, a storage device and a communication interface all coupled together via a bus. The CPU may be implemented as a single microprocessor or as multiple processors for a multi-processing system. The main memory is preferably implemented with a RAM and a smaller-sized cache. The ROM is a non-volatile storage, and may be implemented, for example, as an EPROM or NVRAM. The storage device can be a hard disk drive or any other type of non-volatile, writable storage.

The communication interface provides a two-way data communication coupling, such as to a network. For example, if the communication interface is an integrated services digital network (ISDN) card or a modem, the communication interface provides a data communication connection to the corresponding type of telephone line. If the communication interface is a local area network (LAN) card, the communication interface provides a data communication connection to a compatible LAN. Wireless links are also possible. In any such implementation, the communication interface sends and receives electrical, electromagnetic or optical signals, which carry digital data streams representing different types of information.

The input unit 20, document processing unit 30 and output unit 40 can all be part of a single document processing device, such as a multi-function peripheral (MFP), or may be separate and independent devices. In addition the input unit 20, document processing unit 30 and output unit 40 may each be a single device or two or more interconnected devices. The input unit 20 receives any of a variety of document process requests from the users 20 along with a document to be processed. The document processes include, for example, scanning a document to be saved, receiving a faxed document, copying a document, scanning a document to be faxed, receiving an e-mail message and printing a document. The document process requests can be submitted to the input unit 20 directly from the user device 10, such as from a PC to print a document. Alternatively, the document process requests can be submitted to the input unit 20 at the input unit 20 itself, such as if the input unit 20 is part of an MFP and the document process is to copy a document.

The document process request received by the input unit 20 is then transmitted to the document processing unit 30. The document processing unit 30 receives the document process request and processes it in accordance with the type of document process and any settings associated with the document process. For example, if the document process is to copy a document, the document processing unit 30 prepares a copy of the document in accordance with any settings associated with the copying, such as the number of copies, paper size, stapling, etc.

The results of the processing by the document processing unit 30 are provided by the output unit 40. The results of the completion of the document process include, for example, saving a file to storage, transmitting an e-mail, transmitting a fax or an Internet-fax, saving a file to a box, and printing a document. An Internet fax is an Internet-base facsimile service.

The document processing unit includes a job log 31, a user management information table 32, a job template table 33, a document input/output journal 34 and document storage 35. The job log 31 records information regarding each operation performed by the hardcopy device in processing a document process. More particularly, the job log 31 is an input/output log of document flow, which is created by user operations using a document processing device, such as an MFP, and may include, for example, scan jobs, print jobs and copy jobs. Each entry in the job log 31 may include the date and time the job was created, the status of the job (e.g., successful or failed), who created the job, who received the document, the kind of job, and any job attribute.

The job template table 33 stores job template information that identifies how to perform predetermined document processes. The job template comprises multiple attributes of the job. It is possible for a user to set the attributes of a job template so that the user can perform subsequent jobs with the same attributes without having to reenter the settings. The job template may include a template group attribute, a template attribute and a job attribute. The template group attribute may include a group ID, a group name, a group owner and a group password. The group can include one or more users. The template attribute may include a template ID, a template name, a template owner and a template password. The job attribute may include agent information, which includes an agent ID, name and settings, as well as copy, print and scan information, such as the settings for a particular scan job.

The user management information table 32 includes identification information of users of the hardcopy device, such as in an address table. The document input/output journal 34 collects and stores selected information from the job log 31, the user management information table 32 and the job template table 33 relating to document processes that are processed by the document processing unit 30.

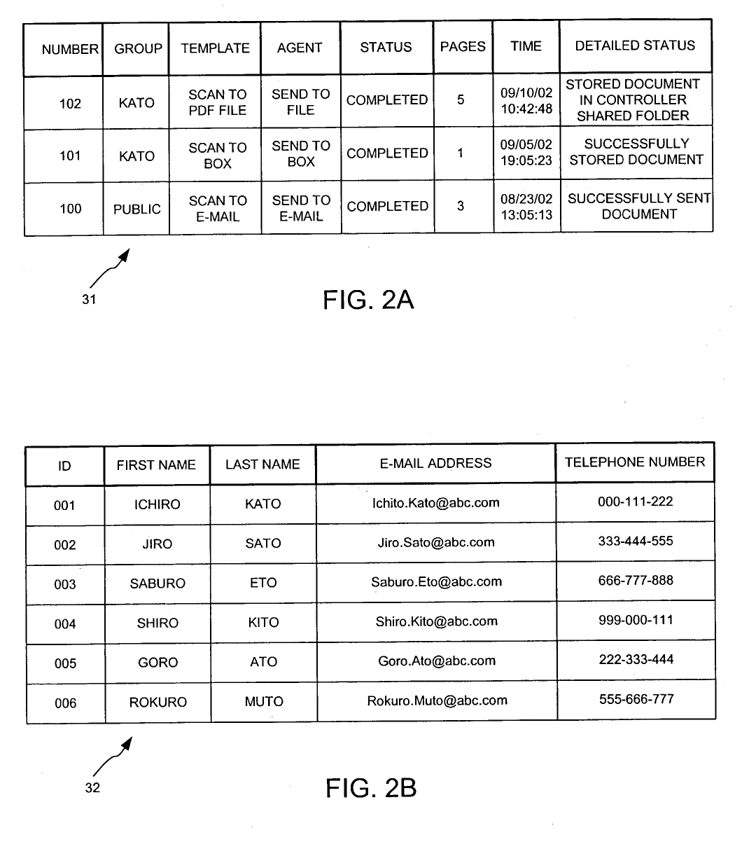

FIG. 2A is an example of a job log 31 according to an embodiment of the present invention. As shown in FIG. 2A, the job log 31 includes a plurality of fields associated with operations performed by the hardcopy device including a unique identification number for each job, a group name, a template, an agent, a status, a number of pages processed, a processing time and a detailed status. It should be understood that any number of fields may be included in the job log 31 in any particular application. For example, the job log 31 may include an ID number of the user submitting the job, a file name or other fields having information accessible to the job log.

FIG. 2B is an example of a user management information table 32 according to an embodiment of the present invention. As shown in FIG. 2B, the user management information table includes an ID number for a user, a user's first and last name, an e-mail address, and a telephone number. Like the job log 31, it should be understood that more or fewer fields may be included in the user management information table 32.

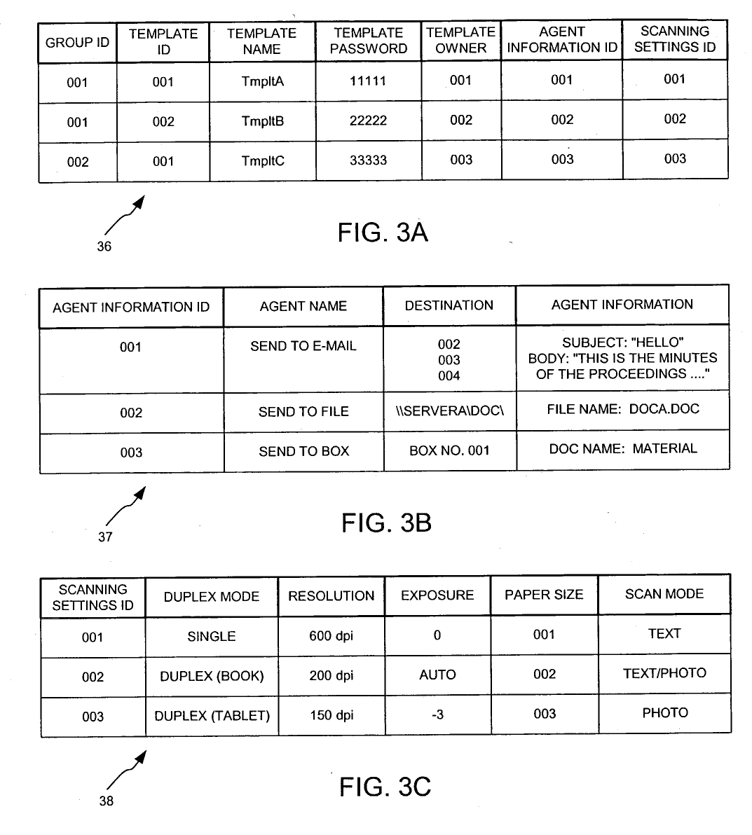

FIGS. 3A, 3B and 3C are examples of a scan job template table 36, an agent information table 37 and a scanning settings table 38, respectively, according to an embodiment of the present invention. Although these examples all relate to scanning processes, it should be understood that there may be corresponding tables for other document processes, such as copying, printing, faxing or e-mailing. Job templates are settings for a particular document process for the hardcopy device, such as an MFP, that are set before a user initiates a document process. For example, a user may have a template to scan a document using particular settings and sending the scanned document to a predetermined set of users. The template can be set up by a user at the user device 10 or at the document processing device where the document process is performed. To set up the template, the programming structure through which the document process is submitted can be configured to prompt the user to enter settings to be saved as a template for future use.

As shown in FIG. 3A, the scan job template table 36, an exemplary version of the job template table 33, has a plurality of fields including a group ID number, a template ID number, a template name, a template password, a template owner (corresponding to user ID number), an agent information ID number and a scanning settings ID number. It should be understood that any number of fields may be included in the job template table 33.

As shown in FIG. 3B, the agent information table 37 has a plurality of fields including an agent information ID number, an agent name, a destination and agent information. The destination identifies to where to send the result of the document process. For example, the destination for send to the sent to e-mail includes three user ID numbers: 002, 003 and 004. It should be understood that more or fewer fields may be included in the agent information table 37.

As shown in FIG. 3C, the scanning settings table 38 has a plurality of fields including a scanning settings ID number, a duplex mode, a resolution, an exposure, a paper size and a scan mode. If the settings table was for copying, then the table may include fields such as number of copies, stapling, paper size, enlarging percentage, etc. Like all of the other tables, the scanning settings table 38 may include any number of fields than shown in FIG. 3C. Another field that may be included in the scanning settings table 38 is a scan rotation mode, such as no rotation, right rotation by 90 degrees, left rotation by 90 degrees or vertical flip-flop.

The agent information table 37 and scanning settings table 38 can be treated as part of the scanning job template table 36, or alternatively, as sub-tables (agent information table 37 and scanning settings table 38) to the primary table (scanning job template table 36). The information in the scanning job template table 36 includes references to the agent information table 37 and scanning settings table 38, which are used to determine the settings and operations to be performed to process a scan job. As shown in FIG. 3A, each template includes an agent information ID number and a scanning settings ID number. These ID numbers are used as indexes to the corresponding agent information table 37 and scanning settings table 38 of FIGS. 3B and 3C. For example, template ID number 001 references agent information ID number 001 and scanning settings ID number 001. The 001 ID number in the agent information table 37 indicates that the result of the scan job is sent by e-mail to three users, identified by their ID number. The 001 ID number in the scanning settings table 38 indicates, among other information, that the scan job is to be scanned with a resolution of 600 dpi.

In addition to the references between the scan job template table 36 and the agent information table 37 and scanning settings table 38, there are also references from these tables to the job log 31 and the user management information table 32, and vice versa. For example, as described above, agent information ID number 001 indicates that a scanned document is sent by e-mail to destinations 002, 003 and 004, which correspond to the user ID numbers of the user management information table 32. Accordingly, the numbers 002, 003 and 004 of the agent information table 37 can be used as an index to the user management information table 32 to determine the e-mail address and names of those users.

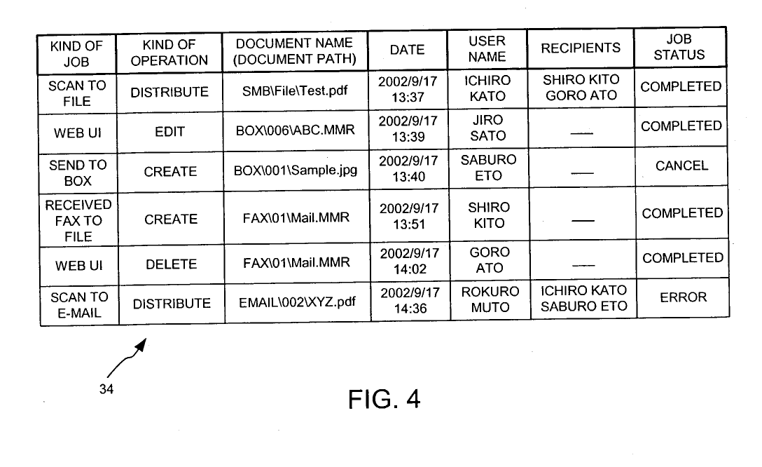

FIG. 4 is an example of a document input/output journal 34 according to an embodiment of the present invention. As described above, the document input/output journal 34 collects and stores selected information from the job log 31, the user management information table 32 and the job template table 33 relating to document processes that are processed by the document processing unit 30. As shown in FIG. 4, the document input/output journal 34 has a plurality of fields including a kind of job, a kind of operation, a document name/path, a date, a user name, recipient names and job status. The document input/output journal 34 can include any number of fields, including any field present in the job log 31, the user management information table 32 and the job template table 33, including field(s) of any associated agent information table and settings table. In addition, the fields in the document input/output journal 34 can be changed and selected by a user, such as a network administrator.

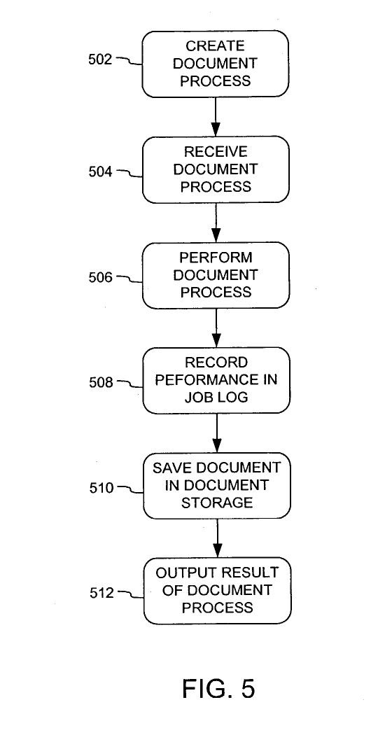

FIG. 5 is a flow diagram for carrying out a document process according to an embodiment of the present invention. As shown in FIG. 5, a user first creates a document process (step 502). As described above, the document process can be printing, copying, faxing, scanning or e-mailing a document. The document process can be created by the user at the user device 10, such as to print a document, or at the document processing device, such as to scan a document. The document processing device can have a touch panel or display with buttons activated by the user to create and initiate the document process.

The document process created by the user is received at the input unit 20 (step 504), and then processed by the document processing unit 30 (step 506). The document processing unit 30 processes the received document process in accordance with the type of document process and any settings associated with the document process.

In addition to processing the received document process, information regarding the performance of the document process is recorded in the job log 31 (step 508). The information recorded can include the kind of job, the ID number of the user submitting the job, the time the job was performed, the status of the job and other related information, such as shown in the job log 31 of FIG. 2A.

Depending upon the type of document process performed, a document is stored in the document storage 35 (step 510). The document storage 35 may serve as a storage area for a document server or may serve as the “box” for the document processing device. The box is a term commonly associated with a document storage area located within and dedicated to a document processing device.

After the document process has been performed, the result of the document process is provided to the user submitting the document process (step 512). The result of the document process is provided by the output unit 40. The user can be provided with the outcome of the document process through a display on the document processing device, through a printout of the result of the document process, such as a confirmation sheet after sending a fax, or through a display at the user device 10, such as a pop-up window or message sent to the user device 10 after the completion of the document process.

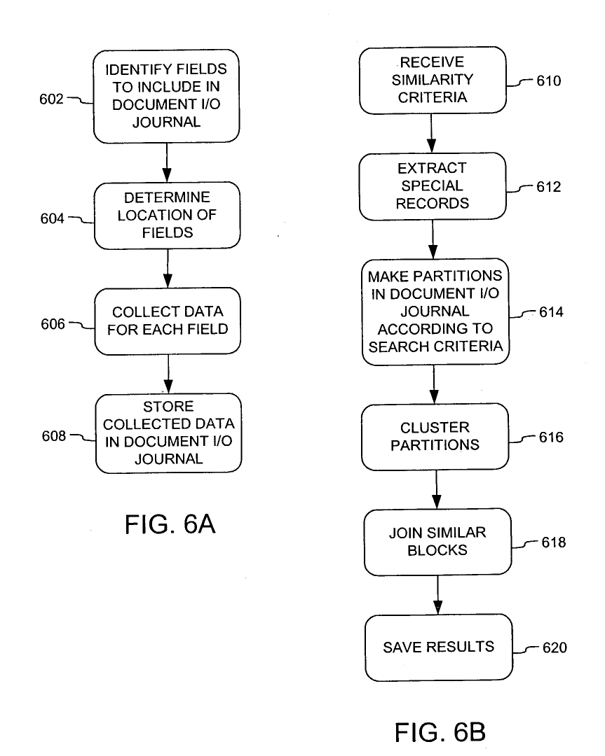

FIG. 6A is a flow diagram for creating the document input/output journal 34 according to an embodiment of the present invention. As shown in FIG. 6A, to create the document input/output journal 34, the categories or fields of the journal 34 are first identified (step 602). The fields in the document input/output journal 34 can be a default group of fields, or specifically selected fields by a user, such as a network administrator.

After identifying the fields, the location of each field is determined (step 604). As explained above, the identified fields may be located in the job log 31, the user management information table 32 and the job template 33, as well as any agent information table and settings table associated with the job template table 33. Identifying the field location may require using information from an information table as a reference or an index to another information table. For example, the job log 31 can have an ID number of a user creating and submitting the document process, but the journal 34 includes a field for that user's name. To identify the name of the user, the ID number is used as an index to the user management information table 32, which shows the correspondence between the ID number and the user name. Other cross references between the job log 31, the user management information table 32, the job template table 33 and any agent information table and settings table associated with the job template table 33 are recognized to be within the scope of the invention.

After identifying the location of the identified fields, the information for those locations is collected (step 606), and the collected information is stored in the document input/output journal 34 (step 608), such as shown in FIG. 4. The manner for storing the information in the journal 34 may be chronological or sorted by some other criteria, such as described below.

The process for creating and updating the journal 34 can be performed by programming structure implemented in the document processing device performing the document processes or implemented in another processing device, such as a server, having access to the various information tables from which is obtained the information collected and stored in the journal 34. In addition, the journal 34 can be updated continuously, in response to some received indication from a user, such as a network administrator, or each time a document process is received or completed.

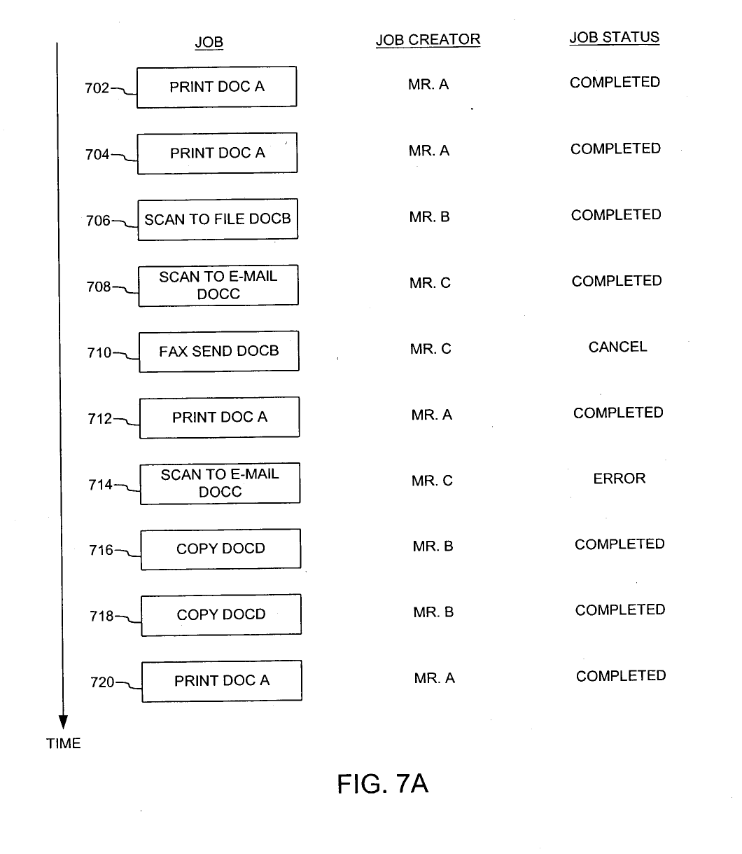

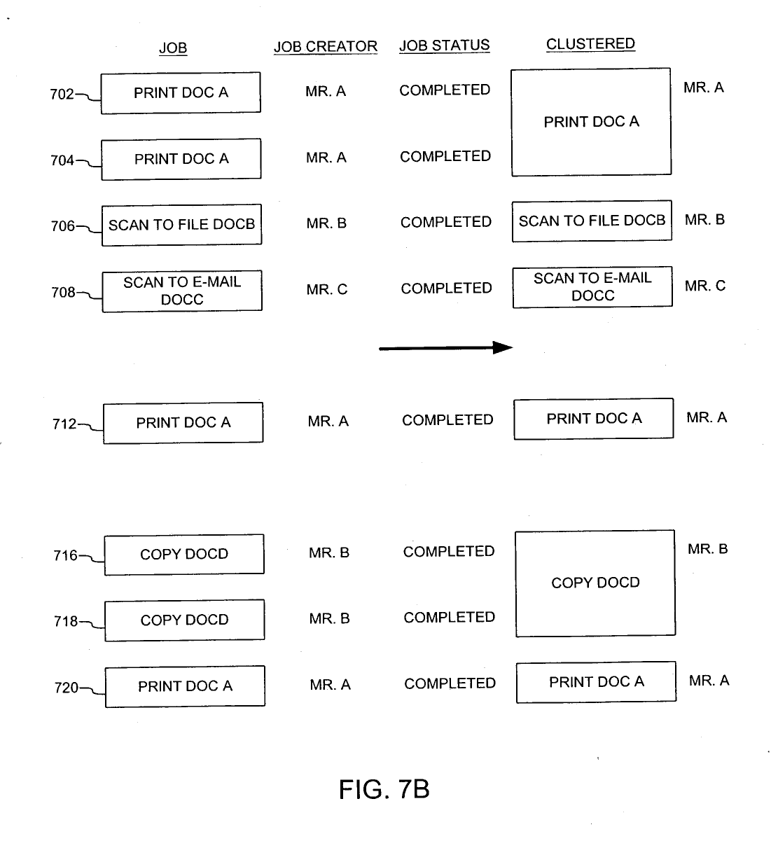

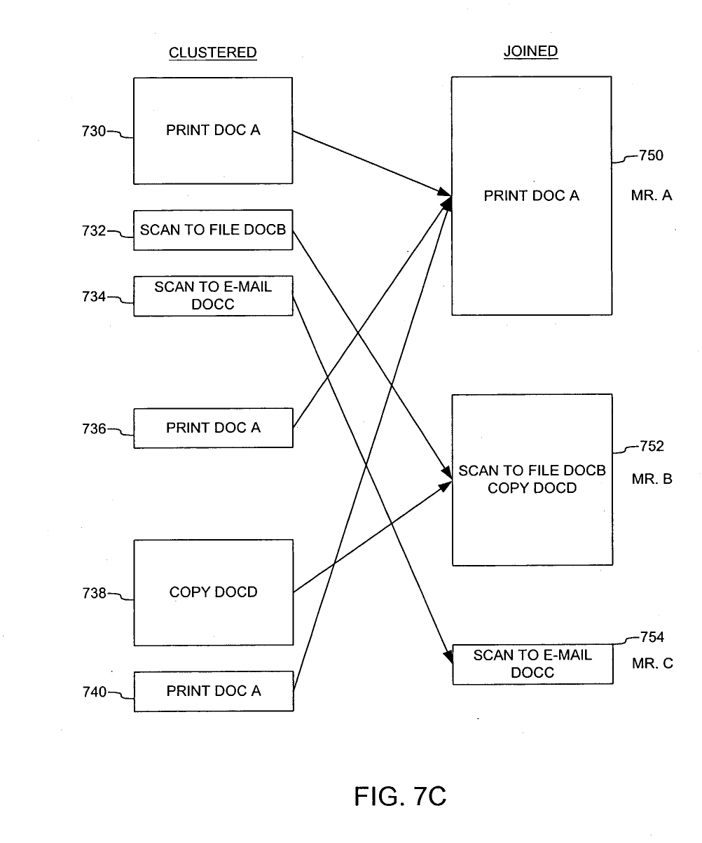

After the document input/output journal 34 is created, it is possible to analyze and restructure the journal 34 or create a new format for the journal according to particular criteria. FIG. 6B is a flow diagram of a process for analyzing the document input/output journal 34 according to an embodiment of the present invention. The process shown in FIG. 6B will be further explained by reference to FIGS. 7A, 7B and 7C, which are examples of a document input/output journal 34 restructured in accordance with the analysis process of FIG. 6B.

As shown in FIG. 6B, first similarity criteria is received (step 610). The similarity criteria can be based on any of the fields in the document input/output journal 34. For example, the similarity criteria can be the user creating the document process, the type of document process, the document involved in the document process, the job template used or some combination thereof. The similarity criteria can be submitted by a user at the user device 10 or at the document processing device corresponding to the document input/output journal 34. For the examples shown in FIGS. 7A-7C, the similarity criteria is the combination of job type and job creator.

After receiving the similarity criteria, special records are extracted from the document input/output journal 34 (step 612). As shown in FIG. 7A, the document input/output journal 34 includes a listing of a plurality of jobs 702-720, as well as the corresponding job creator and job status. The special records can be, for example, jobs having a particular job status, although other criteria can be used. In the example of FIG. 7A, the extracted special records correspond to the jobs that are completed. As shown in FIG. 7B, the extracted records are jobs 702-708, 712 and 716-720.

The extracted records are partitioned according to the received search criteria (step 614). In the examples of FIGS. 7A-7C, the search criteria is a combination of the job type and job creator. As shown in FIG. 7B, jobs 702 and 704 are the same job type and creator, so they are not partitioned. However, jobs 704 and 706 are different, so they are partitioned. Partitions are also made between jobs 706 and 708, jobs 708 and 712, jobs 712 and 716 and jobs 718 and 720.

Jobs between the partitions are then clustered together (step 616). As shown in FIGS. 7B and 7C, jobs 702 and 704 are clustered together into block 730, and jobs 716 and 718 are clustered together into block 738. In addition to clustering the jobs, similar jobs and blocks are joined together. As shown in FIG. 7C, block 730 is joined with blocks 736 and 740 into joined block 750 because they are the same. Block 732 is joined with block 738. Although these latter two blocks do not have the identical job type, they do have the same job creator, which makes them similar blocks that can be joined together.

After joining the blocks together, the results are saved (step 620). The results, which can be referred to as an analyzed journal, can be saved in the format of the document input/output journal 34, but restructured according to the process of FIG. 6B. The analyzed journal can be stored in storage area 35 or in a different storage area accessible to a user. The results can be displayed to the user through a display at the user device 10 or a display on the document processing device.

In addition to viewing the results, the user can also search the analyzed table for particular values. For example, based on the examples of FIGS. 7A-7C, the user can search for a particular document involved in a document process, such as document A, or for a particular person, such as Mr. A. A user can submit the search through an interface of the user device 10 or an interface of the document processing device. The submitted search is applied to the analyzed table, and blocks are identified that match the search.

The process described above with respect to FIGS. 6A and 6B provides several useful functions for users of the document processing device. For example, when drafting a document, the user may print it several times for proofreading. The numerous prints are all for the same print job, which results in a surplus of information stored in the job log 31. With the above-described process, the user can join these print jobs and remove them from the job log 31, thereby maintaining a more efficient storage of jobs.

In addition, a user may repeat a process several times, such as performing a “scan to e-mail” after “copying.” Before the present process, each job process would be separated in the job log 31, even though they may be strongly related to one other. Using the join process as presently disclosed, the user can more readily locate the related processes and related documents.

Another utility for the join process enables a user to join related documents. For example, a user A stores a copied document A in the document processing device, and a user B stores a scanned document B in the document processing device. Subsequently, user C creates a document C from stored documents A and B, and sends document C to user D. Using the join process, it is possible for each of these related jobs to be joined together.

The foregoing description of a preferred embodiment of the invention has been presented for purposes of illustration and description. It is not intended to be exhaustive or to limit the invention to the precise form disclosed, and modifications and variations are possible in light in the above teachings or may be acquired from practice of the invention. The embodiment was chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

What is claimed is:

1. A document processing system for processing document jobs, comprising:
a document input unit that receives a document to be processed by a document process;
a document processing unit that processes the received document in accordance with the document process;
a document output unit that outputs a process result in accordance with the document processing by the document processing unit; and
a document input/output journal management unit, the document input/output journal management unit comprising:
a job log that records information regarding each document process performed by the document processing system;
a user management information table that includes identification information of users of the document processing system; and
a document input/output journal that collects and stores selected information from the job log and the user management information table relating to document processes that are processed by the document processing unit.

2. The document processing system according to claim 1, wherein the document processing system is a multi-function peripheral.

3. The document processing system according to claim 1, wherein the document processing unit is configured to perform at least two of scanning of documents, faxing of documents, copying of documents, printing of documents and electronic mailing of documents.

4. The document processing system according to claim 3, further comprising:
a document storage unit that stores one or more documents input to the document input unit.

5. The document processing system according to claim 4, wherein the document storage unit is further configured to store scanned documents, received faxed documents, and received electronic mail document in the document storage unit.

6. The document processing system according to claim 1, wherein the document input/output journal management unit further comprises a job template table that includes job template information, the job template information identifying how to perform predetermined document processes, and wherein the document input/output journal collects and stores selected information from the job log, the user management information table and the job template table relating to document processes that are processed by the document processing unit.

7. The document processing system according to claim 6, wherein the job template table further includes an agent information table and a document process settings table, the agent information table including information identifying a destination of a document, and the document process setting table including settings for a respective document process, and
wherein the document input/output journal includes selected information from at least one of the agent information table and the document process settings table.

8. The document processing system according to claim 6, wherein the document input/output journal includes at least a job status and a job type information from the job log, a user name information from the user management information table and a document destination information from the job template table.

9. The document processing system according to claim 6, wherein the document input/output journal management unit includes a document input/output journal structure unit, which is configured to receive information identifying which information fields to collect and store from the job log, the user management information table and the job template table.

10. The document processing system according to claim 6, wherein the document input/output journal management unit includes a document input/output journal structure unit, which is configured to receive information identifying which events to collect and store from the job log, the user management information table and the job template table.

11. The document processing system according to claim 1, wherein the document input/output journal management unit includes a document input/output journal structure unit, which is configured to analyze the document input/output journal for similarities between document processes stored in the document input/output journal and restructure the document input/output journal based on the identified similarities.

12. The document processing system according to claim 11, wherein the document input/output journal structure unit is further configured to receive information regarding which similarities with which to analyze the document input/output journal.

13. A method for processing document jobs in a document processing system, comprising:
receiving a document to be processed by a document process;
processing the received document in accordance with the document process;
outputting a process result in accordance with the document processing; and
recording information regarding each document process performed in a job log;
storing identification information of users of the document processing system in a user management information table; and
collecting and storing selected information from the job log and the user management information table in a document input/output journal that relates to the performed document processes.

14. The method according to claim 1, wherein the document processing system is a multi-function peripheral.

15. The method according to claim 1, wherein the document process includes at least two of scanning of documents, faxing of documents, copying of documents, printing of documents and electronic mailing of documents.

16. The method according to claim 3, further comprising:
storing one or more received documents in a document storage unit.

17. The method according to claim 3, further comprising:
storing scanned documents, received faxed documents, and received electronic mail document in a document storage unit.

18. The method according to claim 1, wherein the collecting and storing includes collecting and storing selected information from a job template table that includes job template information, the job template information identifying how to perform predetermined document processes.

19. The method according to claim 6, wherein the job template table further includes an agent information table and a document process settings table, the agent information table including information identifying a destination of a document, and the document process setting table including settings for a respective document process, and
wherein the document input/output journal includes selected information from at least one of the agent information table and the document process settings table.

20. The method according to claim 6, wherein the document input/output journal includes at least a job status and a job type information from the job log, a user name information from the user management information table and a document destination information from the job template table.

21. The method according to claim 6, further comprising:
receiving information identifying which information fields to collect and store from the job log, the user management information table and the job template table.

22. The method according to claim 6, further comprising:
receiving information identifying which events to collect and store from the job log, the user management information table and the job template table.

23. The method according to claim 1, further comprising:
analyzing the document input/output journal for similarities between document processes stored in the document input/output journal; and
restructuring the document input/output journal based on the identified similarities.

24. The method according to claim 11, further comprising:
receiving information regarding which similarities with which to analyze the document input/output journal.
